(19) United States
(12) Patent Application Publication
(10) Pub. No.: US 2025/0306859 A1
(43) Pub. Date: Oct. 2, 2025

(54) APPARATUSES, METHODS, SYSTEMS, AND COMPUTER STORAGE MEDIA FOR ALERT GROUP SUMMARIZATION

(71) Applicant: ATLASSIAN PTY LTD., Sydney (AU)

(72) Inventors: Atri Mandal, Bengaluru (IN); Mayank Sawhney, Bengaluru (IN); Juhi Duseja, Ulhasnagar-Thane (IN); Jayasri Nagrale, Serilingampalle (M) (IN); Prakhar Choudhury, Bengaluru (IN)

(21) Appl. No.: 18/622,016

(22) Filed: Mar. 29, 2024

(51) Int. Cl. G06F 8/10; H04L 41/0631

(52) U.S. Cl. CPC G06F 8/10; H04L 41/0631

(57) ABSTRACT

Apparatuses, methods, systems, or computer-readable storage medium for generating alert group summaries in software management platforms. An alert group comprising a plurality of alert data objects may be identified. One or more alert features associated with the alert group may be extracted based on the plurality of alert data objects and using one or more feature extraction models. Action-related communication content for the alert group may be retrieved. An alert group summary for the alert group may be generated using one or more machine learning models and based on an input data set comprising the one or more alert features and the action-related communication content.

### TECHNICAL FIELD

The present disclosure related generally to alert management; particularly to apparatuses, methods, systems, and computer storage media for generating alert group summaries in software management platforms.

### BACKGROUND

Alert management is an essential aspect of software development and IT service management in a software application framework. Applicant has identified many deficiencies and problems associated with alert management tools. Through applied effort, ingenuity, and innovation, these identified deficiencies and problems have been solved by developing solutions that are in accordance with the embodiments of the present invention, many examples of which are described in detail herein.

### BRIEF SUMMARY

Embodiments of the present disclosure relate to apparatuses, methods, systems, and computer storage media for generating alert group summaries in software management platforms. In accordance with one aspect, an apparatus for generating alert group summaries is provided, the apparatus comprising at least one processor and at least one memory including program code, the at least one memory and the program code configured to, with the at least one processor, cause the apparatus to at least identify an alert group comprising a plurality of alert data objects; extract, based on the plurality of alert data objects and using one or more feature extraction models, one or more alert features associated with the alert group; extract action-related communication content for the alert group; generate, using one or more machine learning models and based on an input data set comprising the one or more alert features and the action-related communication content, an alert group summary for the alert group; and cause rendering of an alert group summary interface on a display of a user device, wherein the alert group summary interface comprises at least a portion of the alert group summary.

In some embodiments, the one or more alert features comprises entity data corresponding to one or more entities associated with the alert group.

In some embodiments, the input data set further comprises behavioral insights comprising one or more of fault localization data, blast radius data, or fault propagation path data.

In some embodiments, the behavioral insights is generated based on the entity data and topology data.

In some embodiments, the one or more feature extraction models comprises a BILSTM-CRF-NER model, wherein the at least one memory and the program code are configured to, with the at least one processor, cause the apparatus to extract the entity data from the plurality of alert data objects using the BILSTM-CRF-NER model.

In some embodiments, the one or more alert features comprises action notes corresponding to one or more actions by a user associated with the alert group.

In some embodiments, the one or more machine learning models comprise a pre-trained LLM, wherein the at least one memory and the program code are configured to, with the at least one processor, cause the apparatus to generate the alert group summary via the pre-trained LLM using retrieval augmented generation and based on the input data set.

In some embodiments, the input data set further comprises context data obtained via a domain knowledge graph.

In some embodiments, the alert group summary comprises a title segment, a comprehensive summary segment, an actions summary segment, and a timeline segment.

In some embodiments, the at least one memory and the program code are configured to, with the at least one processor, cause the apparatus to at least identify the alert group by receiving an alert group identifier; and identifying the alert group based on the alert group identifier.

In accordance with another aspect, a computer-implemented method for generating alert group summaries is provided, the computer-implemented method comprising extracting, based on a plurality of alert data objects of an alert group and using one or more feature extraction models, one or more alert features associated with the alert group; generating, using one or more machine learning models and based on an input data set comprising the one or more alert features, an alert group summary for the alert group; and causing rendering of an alert group summary interface on a display of a user device, wherein the alert group summary interface comprises at least a portion of the alert group summary.

In some embodiments, the one or more alert features comprise entity data corresponding to one or more entities associated with the alert group.

In some embodiments, the input data set further comprises behavioral insights comprising one or more of fault localization data, blast radius data, or fault propagation path data.

In some embodiments, the behavioral insights is generated based on the entity data and topology data.

In some embodiments, the one or more feature extraction models comprises a BILSTM-CRF-NER model, wherein extracting the one or more alert features comprises extracting the entity data from the plurality of alert data objects using the BILSTM-CRF-NER model.

In some embodiments, the one or more alert features comprises action notes corresponding to one or more actions by a user associated with the alert group.

In some embodiments, the one or more machine learning models comprises a pre-trained LLM, wherein generating the alert group summary comprises retrieval augmented generation via the pre-trained LLM and based on the input data set.

In some embodiments, the input data set further comprises context data obtained via a domain knowledge graph.

In some embodiments, the alert group summary further comprises a title segment, a comprehensive summary segment, an actions summary segment, and a timeline segment.

In accordance with another aspect, at least one non-transitory computer-readable storage medium for generating alert group summaries is provided, the at least one non-transitory computer-readable storage medium having computer coded instructions configured to, when executed by at least one processor identify an alert group comprising a plurality of alert data objects; generate, using one or more machine learning models and based on one or more alert features associated with the alert group and action-related communication content from one or more communication platforms, an alert group summary for the alert group; and cause rendering of an alert group summary interface on a display of a user device, wherein the alert group summary interface comprises at least a portion of the alert group summary.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example alert group summarization system architecture within which at least some embodiments of the present disclosure may operate,

FIG. 2 is a block diagram of an alert group summarization apparatus in accordance with at least some embodiments of the present disclosure.

FIG. 3 is a block diagram of an example client computing device structured in accordance with at least some embodiments of the present disclosure.

FIG. 4 illustrates a visualization of an example data environment for alert group summarization in accordance with at least some embodiments of the present disclosure.

FIG. 5 is an example alert group summarization interface in accordance with at least some embodiments of the present disclosure.

FIG. 6 is a flow chart diagram of an example process for generating alert group summaries in accordance with at least some embodiments of the present disclosure.

### DETAILED DESCRIPTION OF SOME EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

Alert management is an essential aspect of running a successful software application framework. Alert management systems are configured to provide and facilitate alert management in software application frameworks. Such alert management systems generate huge volumes of alerts that must be reviewed and disposed of by alert managers. Alert overload may be particularly acute in service-orientated platforms as large numbers of alerts might be triggered by each service or microservice of the service-oriented platform. Alert overload may produce alert fatigue that may in turn lead to errors and potential service outages; particularly, if the alert managers are required to manually search through or assess huge volume of alerts for relevant information.

According to various embodiments, there is provided a system, method, apparatus, and/or a computer program that is configured to provide a comprehensive summary for an alert group comprising a set of alerts that satisfy specified criteria.

Example embodiments are configured to identify an alert group (e.g., generated by correlating topological and temporal alerts) comprising a plurality of alert data objects and extract one or more alert features associated with the alert group. The one or more alert features comprise action notes, problem descriptions, entity data, or the like. Example embodiments leverage a Bi-directional-Long-Short Term Memory-Conditional Random Field Named Entity Recognition (BILSTM-CRF-NER) model to extract entity data from the plurality of alert data objects.

Example embodiments generate an alert group summary for the alert group based on at least a portion of the one or more alert features and using one or more machine learning models. In example embodiments, the alert group summary comprises a plurality of alert group summary segments including a title segment, a comprehensive summary segment, an actions summary segment, and a timeline segment.

In example embodiments, the one or more machine learning models leveraged to generate the alert group summary comprise a pre-trained LLM. Example embodiments generate the alert group summary via the pre-trained LLM using retrieval augmented generation. For example, various embodiments leverage a domain knowledge graph (e.g., retrieved from the knowledge graph repository) to identify context data (e.g., relevant snippets) that is input to the pre-trained LLM along with the alert features and communication content from one or more communication platforms to provide context for the pre-trained LLM. Example embodiments cause rendering of an alert group summary interface to a display, where the alert group summary interface comprises at least a portion of the alert group summary.

By leveraging a pre-trained LLM to generate an alert group summary using retrieval augment generation and relevant snippets from a domain knowledge graph along with alert features, embodiments of the present disclosure provide a deep summarization for the alert group (e.g., as opposed to just an abstractive summary). For example, embodiments of the present disclosure do not merely summarize a set of inputs but rather identifies additional relevant information (e.g., context) based on the set of inputs and leverage a pre-trained LLM to generate text that comprise a summary for the alert group based on the set of inputs and the additional relevant information. By providing a deep summarization for the alert group, various embodiments help alert managers and other users to swiftly understand the problem(s) associated with large alert groups without having to review each individual alert or consult other sources for additional information. This in turn reduces network computation load as large alert group related data need not be transmitted to alert manager client devices thereby freeing up network resources. Alert processing efficiency is also improved as evidenced by reductions in important metrics such as mean time to recovery (MTTR).

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” refers to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “alerts” refers to one or more cautions, problems, errors, issues, flags, monitored events, and/or incidents that are generated by an alert management system that is configured to monitor a software application framework. Alerts are embodied as any data construct and/or data object generated by an alert management system indicating the status and/or operating characteristic of a component, module, service, microservice, feature, application, and/or device within a software application framework. Such operating characteristic may include indicators regarding the performance of a component (e.g., whether the component and its functions are running at peak speed or slower than peak speed, if certain functions or capabilities are not running at peak performance or not running at all, or more benignly, if some performance metric or parameter is designed to be on interest for regular reporting even if such parameter does not represent a degradation in performance, etc.). Further, operating functionality may include security threats (e.g., unauthorized access, data breaches, etc.), compliance issues (e.g., violation of data privacy), system failures (e.g., application crash, server down, network connection lost, etc.). In some embodiments, an alert is embodied as or is associated with an alert data object which includes alert attributes that are extracted as alert features as defined herein.

The term “alert data object” refers to one or more properties associated with execution, operation, maintenance, configuration management, and/or the like of a software application framework, being monitored (e.g., by alert management system), during normal operation and/or post experiencing an abnormal state (e.g., unplanned interruption to a service, reduction in the quality of a service, failure of a service, or the like) of the software application framework. An alert data object may embody data and instructions that describe an alert (e.g., an indication of an event that occurred in an external system, application, or service that is monitored by an alert management system, monitored by a program associated or integrated with an alert management system, or directly associated with an alert management system).

In some embodiments, the alert data object includes a plurality of alert attribute data fields associated with the alert. Examples of alert attribute data fields of an alert data object include a message attribute data field that stores message data that indicates the basis of the alert creation, a teams attribute data field that includes the names of the teams that were added to the alert to be notified, a recipients attribute data field that includes the names of recipients that were added to the alert to be notified, an entity attribute data field that is used to specify the domain that the alert is related to, such as name of the service, server, or application, a description attribute data field that is used to keep a long description related with the alert, action notes attribute data field that is used to specify and/or summary actions (e.g., corrective actions, or the like) taken with respect to the alert, and/or an extra properties field that is used to keep additional key-value pairs related with the alert.

Other examples of alert attribute data fields include status attribute data field that contains the information of alert state, a recipient states attribute data field that shows the last state of the recipient users according to the alert, a notes attributes field that shows the notes (e.g., alert summary notes, or the like) that were added initially or later by users, and an activity log attributes field that provides any user or system activity related to an alert along with their update times on this section with the time sequence. Alert creation, user interactions including actions, notifying or skipping to notify a user, de-duplication events are some of the example activities. A user may be required to manually enter some of the attribute data field information mentioned above, and/or an alert management client or server may automatically populate some attribute data field information. Other examples of alert attribute data fields of an alert data object include one or more numerical attribute data fields, such as a numerical attribute data field describing the deduplication count of the alert data object, a numerical attribute data field describing the number of other alert data objects created during a defined window (e.g., 15-minute window or the like) around the creation time of the alert data object, a numerical attribute data field describing the number of nth priority level alert data objects created during a defined window around the creation time of the alert data object, an average inter-arrival time of alert data objects at the creation time of the alert data object, and/or the like. Other examples of alert attribute data fields of an alert data object include one or more categorical attribute data fields, such as a categorical attribute data field describing the priority level of the alert data object (e.g., describing whether the alert data object is P1, P2, P3, P4, or P5), a categorical attribute data field describing the alert source of the alert data object (e.g., describing whether the alert data object is user-initiated, system-initiated, request-initiated, and/or the like), a categorical attribute data field describing whether the creation time of the alert data object is a weekend or a weekday, and/or the like. Other examples of alert attribute data fields for an alert data object includes an embedded representation of a natural language format field (e.g., an alert message field) of the alert data object, such as an embedded representation generated based on the output of processing the alert message field of the alert data object using a text encoder machine learning model.

The term “alert group” refers to a data entity that describes or otherwise correlates a group of alert data objects that are deemed to be related based on one or more grouping criteria. For example, an alert group may comprise a plurality of alert data objects that are similar to one another and/or correlate with one another based on one or more grouping criteria (e.g., one or more similarity criteria, one or more correlation criteria, and/or the like). In some embodiments, an alert group describes an output of a model such as an alert clustering machine learning model configured to group alert data objects into alert groups.

The term grouping criteria refers to a data entity that describes an attribute based on which a set of alert data objects can be separated into or otherwise associated with an alert group. Examples of grouping criteria include similarity between alert data objects based on alert attribute features (e.g., common entities, common alert message, common team identifier, common alert creation window (e.g., days of the week), and/or the like), correlation between alert data objects based on alert attribute features, and/or the like.

The term “alert group identifier” refers to one or more items or elements by which an alert group may be uniquely identified from other alert groups. An alert group identifier may be in the form of text string(s), numerical character(s), alphabetical character(s), alphanumeric code(s), American Standard Code for information Interchange (ASCII) characters(s), and/or the like. An alert group identifier may be used identify alerts in an alert group.

The term “alert group signature” refers to a data entity that describes a representation of the alert group. For example, the alert signature may comprise a hash for the alert group and may be generated based on the problems associated with the alert group. In some embodiments, an alert group signature for a particular alert group is leveraged to identify historical alerts and/or alert groups that are similar to the particular alert group (e.g., alerts and/or alert groups in the past associated with similar problems as the particular alert group). In some embodiments, the historical alerts and/or alert groups may be leveraged to generate at least a portion of an alert group summary. For example, the historical alerts and/or historical alert groups identified to be similar to a particular alert group may be included in the alert group summary for the particular alert group and/or used to identify relevant information that may be included in the alert group summary for the particular group.

The term “alert feature” describes an alert attribute data fields of an alert data object and/or an embedded representation of a natural language format field (e.g., an alert message field) of the alert data object. For example, alert features describes any data, object, detail, attribute, embedding transformation, or the like that is extracted from an alert data object or alert group by a feature extraction model for use by one or more modules or one or more machine learning models (e.g., pre-trained LLM). Such alert features may include embedding or vector transformations of text (e.g., alert message components, problem descriptions, etc.), software identifiers, service or microservice identifiers, and other data or metadata that are configured for input into a machine learning model such as a pre-trained LLM.

The terms “user-generated content” refers to data, objects, and/or the like that is input by or generated by a user. Examples of user-generated content include data input by a user in an attribute data field of an alert data object such as alert descriptions, alert notes, responder names, and/or the like. Other examples of user-generated content include data (e.g., action-related communication content) input by a user via a communication platform such as Slack, Teams, or the like. In some embodiments, user-generated content refers to a type of data classification that is associated with a data object created by one or more users of an application that generated the data object (e.g., free-form text, audio files, video files, the like, or combinations thereof).

The terms “machine learning module,” “machine learning model,” “ML module(s),” or “ML model(s)” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models. In various embodiments, the ML model includes a pre-trained LLM. In various embodiments, the pre-trained LLM is leveraged to generate an alert group summary that is a deep summarization of the various information/data associated with the alert group using retrieval augmented generation.

The term “alert group summary” as used herein refers to a deep summarization generated for an alert group. For example, while an abstractive summarization for an alert group may be generated by extracting data from alert attribute data fields of alert data objects associated with the alert group and paraphrasing the text data to provide a short description of key ideas from the data, a deep summarization for an alert group as described herein augments text data extracted from alert attribute data fields of the alert data objects with additional relevant information obtained via a domain knowledge graph (e.g., a knowledge base associated with the respective enterprise/enterprise platform). The additional relevant information is provided to a pre-trained LLM as context to generate a deep summary of the various information (e.g., including the additional relevant information) associated with the alert group while also reducing or preventing hallucinations by the pre-trained LLM.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

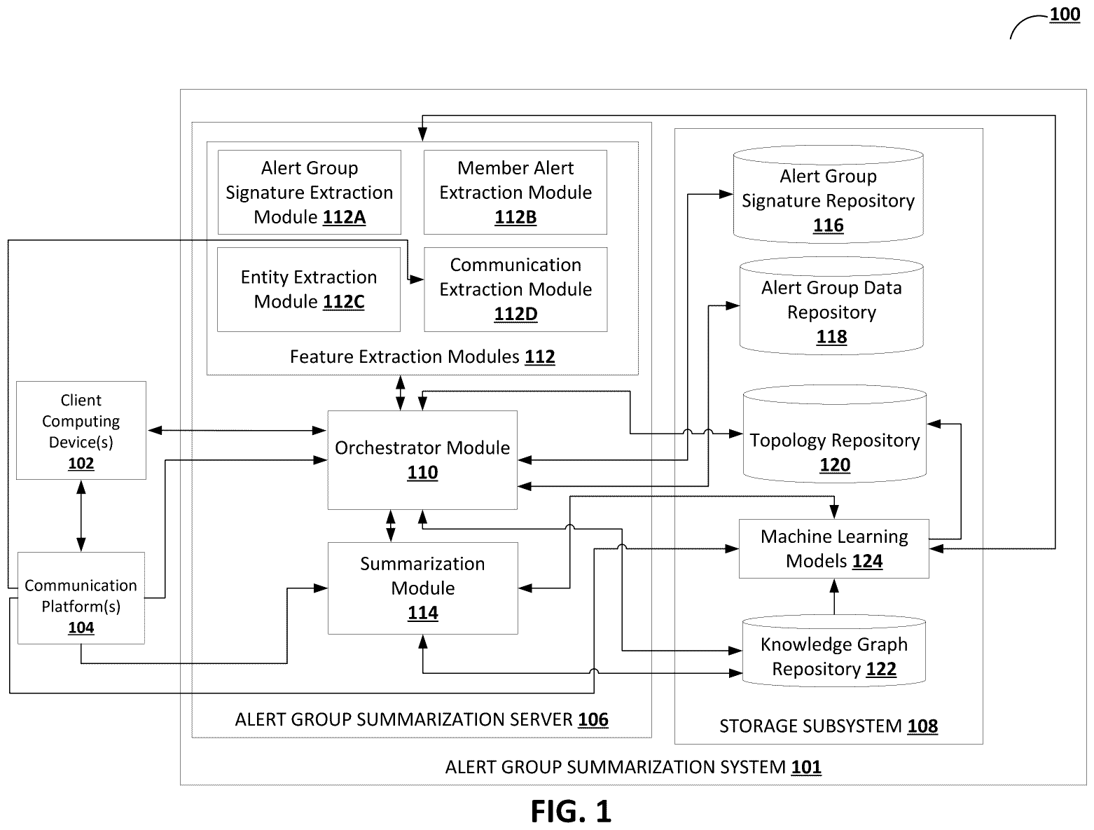

FIG. 1 provides an example alert group summarization system architecture 100 within which embodiments of the present disclosure may operate. The depiction of the example alert group summarization system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the alert group summarization system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1, the alert group summarization system architecture 100 includes an alert group summarization system 101, one or more client computing devices 102, and one or more communication platforms 104. The alert group summarization system 101 may be configured to identify alert groups, automatically generate alert group summaries for the alert groups, and cause rendering of the alert group summaries to one or more client computing devices 102. The alert group summarization system 101 may be configured to utilize one or more machine learning models 124 to generate an alert group summary or otherwise to facilitate performance of various functionalities associated with generating alert group summaries. For example, the one or more machine learning models 124 may include a pre-trained large language model (LLM) configured to generate an alert group summary based on an input data set for the alert group. In some embodiments, the alert group summary comprises a comprehensive summary segment. Additionally, in some embodiments, the alert group summary comprises one or more of a title segment (e.g., a concise summary segment, short summary segment, or similar terms used herein), an actions summary segment, and a timeline segment.

In some embodiments, an alert group comprises one or more alerts deemed as being related. In some embodiments, an alert may be embodied as or is associated with an alert data object which includes alert attributes that are extracted as alert features as further described herein.

In some embodiments alerts are one or more cautions, problems, errors, issues, flags, and/or incidents that are generated by an alert management system that is configured to monitor a software application framework. Alerts are embodied as any data construct and/or data object generated by an alert management system indicating the status and/or operating functionality of a component, module, service, microservice, feature, application, and/or device within a software application framework. Such operating functionality may include indicators regarding the performance of a component (e.g., whether the component and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.). In some embodiments, an alert is embodied as or is associated with an alert data object which includes alert attributes that are extracted as alert features as defined herein.

In some embodiments, the functions of one or more of the illustrated components in FIG. 1 may be performed by a single computing device or by multiple computing devices, which devices may be local or cloud based. It will be appreciated that the various functions performed by the alert group summarization system 101, the one or more client computing devices 102, and/or the one or more communication platforms 104 may be embodied by a single apparatus, subsystem, or system comprising one or more sets of computing hardware (e.g., processor(s) and memory) configured to perform the various functions thereof. For example, in some embodiments, one or more of the components of the alert group summarization system 101 and/or one or more communication platforms 104 may be embodied by a client computing device 102.

In the depicted embodiment, as shown in FIG. 1, the alert group summarization system 101 includes an alert group summarization server 106 and a storage subsystem 108. The storage subsystem 108 may store one or more repositories including, but not limited to, alert group signature repository 116, alert group data repository 118, topology repository 120, and knowledge graph repository 122. In some embodiments two or more of the alert group signature repository 116, alert group data repository 118, topology repository 120, and/or knowledge graph repository 122 may be embodied in a single repository. For example, two or more of the alert group signature repository 116, alert group data repository 118, topology repository 120, and/or knowledge graph repository 122 may each comprise a partition within a single repository. In an example embodiment, the alert group repository 116 and the alert group data repository 118 are embodied in a single repository (e.g., comprise separate partitions within a single repository). Additionally, the storage subsystem 108 may be configured to store one or more machine learning models 124.

The alert group summarization server 106 may be configured to perform various functionalities of the alert group summarization system 101 including, but not limited to, identifying alert groups, extracting member alert data, extracting action-related communication content from one or more communication platforms 104, generating action insights, generating behavioral insights, automatically generating alert group summaries for the alert groups (e.g., using a pre-trained LLM and retrieval augment generation), and causing rendering of the alert group summaries to a display of one or more client computing devices 102.

In the depicted embodiment, as shown in FIG. 1, the alert group summarization server 106 includes an orchestrator module 110, one or more feature extraction modules 112, and a summarization module 114. In the depicted embodiment, as shown in FIG. 1, the one or more feature extraction modules 112 include an alert group signature extraction module 112A, a member alert extraction module 112B, an entity extraction module 112C, and a communication extraction module 112D. It would be appreciated that in some embodiments, the alert group summarization server 106 may include additional extraction modules and/or may not include one or more of the extractions modules depicted in FIG. 1. Each of the orchestrator module 110, one or more feature extraction modules 112, and summarization module 114 may be any means such as a device or circuitry embodied in either hardware, software, or a combination of hardware and software configured to facilitate and/or perform one or more functionalities associated with generating alert group summaries.

The orchestrator module 110 may be configured to orchestrate or otherwise facilitate various functionalities associated with automatically and intelligently generating alert group summaries as described herein, including receiving and/or transmitting, one or more datasets, objects, instructions, and/or the like from and/or to one or more other modules (e.g., the one or more feature extraction modules 112 and/or summarization module 114) and outputting data and/or instructions configured to cause rendering of one or more alert group summary user interfaces. In some embodiments, the datasets, objects, and/or the like received and/or transmitted by the orchestrator module may comprise input to a machine learning model and/or output of a machine learning model as further described herein.

In some embodiments, the orchestrator module 110 is configured to receive an alert group identifier (e.g., via a web user interface rendered in a client computing device 102) and transmit data and/or instructions to the one or more feature extraction modules 112 to cause the one or more feature extraction modules 112 to extract one or more alert features associated with the alert group and/or to extract action-related communication content from one or more communication platforms as described further below. The one or more alert features and action-related communication content may be leveraged by one or more modules (e.g., summarization module 114) of the alert group summarization server 106 to perform one or more functionalities associated with generating alert group summaries as described herein. In some embodiments, one or more feature extraction models are leveraged by the one or more feature extraction modules 112 to extract the one or more alert features and/or action-related communication content.

In some embodiments, the orchestrator module 110 is configured to, in response to receiving an alert group identifier (e.g., via a web user interface rendered on a client computing device 102), transmit data and/or instructions to the alert group signature extraction module 112A configured to cause the alert group signature extraction module 112A to extract the alert group signature associated with the alert group identifier and provide the extracted alert group signature to the orchestrator module 110. The orchestrator module 110 may be configured to provide the alert group signature to one or more modules of the alert group summarization server 106 to facilitate generation of at least a portion of the alert group summary. In some embodiments, the alert group signature for a particular alert group is leveraged to identify similar historical alerts and/or similar historical alert groups (e.g., alerts and/or alert groups that are similar to the alert group). In some embodiments, the similar historical alerts and/or similar historical alert groups may be leveraged to generate at least a portion of an alert group summary. For example, the similar historical alerts and/or similar historical alert groups may be included in the alert group summary for the particular alert group and/or used to identify relevant information and/or generate insights that may be included in the alert group summary. In some embodiments, the alert group signature extraction module retrieves the alert group signature from the alert group signature repository 116 and provides the retrieved alert group signature to the orchestrator module 110. In some embodiments, the alert group signature extraction module 112A leverages a feature extraction model to extract the alert group signature.

In some embodiments, the orchestrator module 110 is configured to transmit data and/or instructions to the member alert extraction module 112B configured to cause the member alert extraction module 112B to extract one or more alert data objects associated with the alert identifier (e.g., one or more alert data objects that belong to the alert group) and/or member alert data (e.g., data associated at least a subset of the one more alert data objects in the alert group). For example, the one or more alert groups may comprise a subset of the alert data objects in the alert group representative of the alert group. The orchestrator module 110 may be configured to provide the one or more alert data objects and/or member alert data to one or more modules (e.g., entity extraction module 112C, summarization module 114) of the alert group summarization server 106 to facilitate generation of at least a portion of the alert group summary. In some embodiments, the member alert extraction module 112B retrieves the one or more alert data objects associated with an alert group identifier from the alert group data repository 118. For example, the member alert extraction module may receive the alert group identifier from the orchestrator module 110 and leverage the alert group identifier to identify and retrieve a subset of the alert data objects in the alert group that is associated with the alert group identifier. In some embodiments, the member alert extraction module 112B extracts member alert data associated with the one or more alert data objects and provides the member alert data to the orchestrator module 110. In some embodiments, member alert data is alert data extracted from an individual alert data object of the alert group. The member alert data may comprise semantic insights such as alert description, problem description, action notes, and/or alert title extracted from alert data objects in the alert group. In some embodiments, the member alert extraction module 112B leverages a feature extraction model to extract the one or more alert data objects from the alert group and/or to extract member alert data associated at least a subset of the alert data objects of the alert group.

In some embodiments, the orchestrator module 110 is configured to transmit data and/or instructions to the entity extraction module 112C configured to cause the entity extraction module 112C to extract entity data that comprise one or more entities (e.g., service, region, reason, error code, and/or the like) associated with the alert group. The orchestrator module 110 may be configured to provide the alert data objects and/or member alert data extracted from the alert data objects to the entity extraction module. The entity extraction module 112C may be configured to extract the entity data from the one or more alert data objects and/or member alert data in response to receiving the alert data objects, member alert data, and/or instructions from the orchestrator module 110. In some embodiments, the entity extraction module 112C leverages a feature extraction model to extract the entity data. In some embodiments the feature extraction model leveraged by the entity extraction module 112C comprise a machine learning model (e.g., one of the one or more machine learning models 124). In some embodiments, the feature extraction model leveraged by the entity extraction module 112C to generate the entity data comprises a BILSTM-CRF-NER model.

The entity extraction module 112C may be configured to provide the one or more entity data to the orchestrator module 110. The orchestrator module 110 may be configured to provide the entity data to one or more modules (e.g., summarization module 114) of the alert group summarization server 106 to facilitate generation of an alert group summary.

In some embodiments, the orchestrator module 110 is configured to transmit data and/or instructions to the communication extraction module 112D configured to cause the communication extraction module 112D to extract action-related communication content (e.g., conversations, messages, and/or the like) from at least one of the one or more communication platforms 104. In some embodiments, the action-related communication content may comprise conversations, messages, and/or the like describing actions taken with respect to a member alert in the alert group). In some embodiments, the orchestrator module 110 is configured to provide the action-related communication content to one or more modules (e.g., summarization module 114) of the alert group summarization server 106 to facilitate generation of at least a portion of the alert group summary. For example, the action-related communication content may comprise actions insights leveraged by the summarization module 114 to generate the action summary segment of an alert group summary or at least a portion thereof.

In some embodiments, the orchestrator module 110 is configured transmit data and/or instructions configured to cause at least one machine learning model of the one or more machine learning models 124 to generate behavioral insights for an alert group. In some embodiments, input to the at least one machine learning model includes entity data (e.g., extracted by the entity extraction module 112C). In some embodiments, the at least one machine learning model leverages topology data (e.g., from the topology repository 120) with the entity data to generate behavioral insights for an alert group. In some embodiments, the entity extraction module 112C or another module associated with the alert group summarization server 106 may receive the data and/or instructions from the orchestrator module 110 and generate the behavioral insights for the alert group using the at least one machine learning model (as described above). In some embodiments, the behavioral insights output by the at least one machine learning model comprise fault localization data, blast radius data, and/or fault propagation path data. The orchestrator module 110 may be configured to provide the behavioral insights to one or more modules (e.g., summarization module 114) of the alert group summarization server 106 to facilitate generation of at least a portion of the alert group summary. For example, the behavioral insights may be leveraged by the summarization module 114 to generate at least a segment of the alert group summary that describes fault localization, blast radius, fault propagation path and/or other behavioral insights associated with the alert group. In some embodiments, fault localization may describe or otherwise comprise a root cause of a problem associated with the alert group (e.g., service(s) that is determined to cause or likely to have caused the problem(s) associated with the alert group). In some embodiments, blast radius may describe inferred impact of a problem associated with the group (e.g., services that may be affected by the problem). In some embodiments, fault propagation path may describe cause-effect relations with respect to the root cause of a problem associated with the alert group. In some embodiments, as described above, the behavioral insights may be generated using at least one machine learning model and based on entity data and topology data. For example, the at least one machine learning model may process the entity data with respect to the topology data to output behavioral insights. The topology data may be retrieved from the topology repository 120. In some embodiments, the topology data may be embodied as a graph structure (e.g., service dependency graph structure, causal graph structure, or the like) that describes relationships between services and/or other entities. The at least one machine learning model may be configured to traverse the graph structure to output the behavioral insights for an alert group.

In some embodiments, the orchestrator module 110 is configured to transmit data and/or instructions to the summarization module 114 configured to cause the summarization module 114 to generate an alert group summary via a pre-trained LLM and using retrieval augmented generation along with a domain knowledge graph. The summarization module 114 may be configured to generate an alert group summary for an alert group based on input data set comprising action insights (e.g., action-related communication content, action notes, and/or the like), behavioral insights (e.g., fault localization data, blast radius data, fault propagation path data, and/or the like), and/or entity data. In some embodiments, additionally, the input data set may include the alert group identifier and/or alert features associated with similar historical alert groups identified based on the alert group signature and/or insights generated via the similar historical alert groups. The summarization module 114 may receive the input data set or at least a portion of the input data set from the orchestrator module 110. Additionally, the input data set may include context data (e.g., relevant snippets) obtained from a domain knowledge graph. For example, the orchestrator module 110 may be configured to query the domain knowledge graph with respect to, for example, user-generated content (e.g., action notes, action-related communication content, and/or the like) extracted from alert data objects and/or communication platforms. For example, the orchestrator module 110 may query the domain knowledge graph for description, context, details, explanation, and/or the like of one or more terms from the user-generated content. In this regard, the summarization module 114 may be configured to generate an alert group summary that is a deep summarization for the alert group (e.g., as opposed to just an abstractive summary).

Two or more of the components illustrated in the alert group summarization system 101 and the alert group summarization system architecture 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In some embodiments, the components depicted in FIG. 1 as being included in the alert group summarization system 101, although not required to be an integral system, may be connected via one or more networks. In some embodiments, one or more APIs may be leveraged to communicate with and/or facilitate communication between one or more of the components illustrated in the alert group summarization system 101 and alert group summarization system architecture 100. It should be appreciated that while in the illustrated embodiment of FIG. 1, the orchestrator module 110 is configured to facilitate communication of data, objects, and/or the like between various modules (e.g., feature extraction module 112, summarization module 114) of the alert group summarization server 106, in some embodiments, alternatively or additionally, one or more modules of the alert group summarization server 106 may be configured to communicate directly with each other.

### Example Apparatuses of the Disclosure

Having discussed example systems in accordance with the present disclosure, example apparatuses in accordance with the present disclosure will now be described.

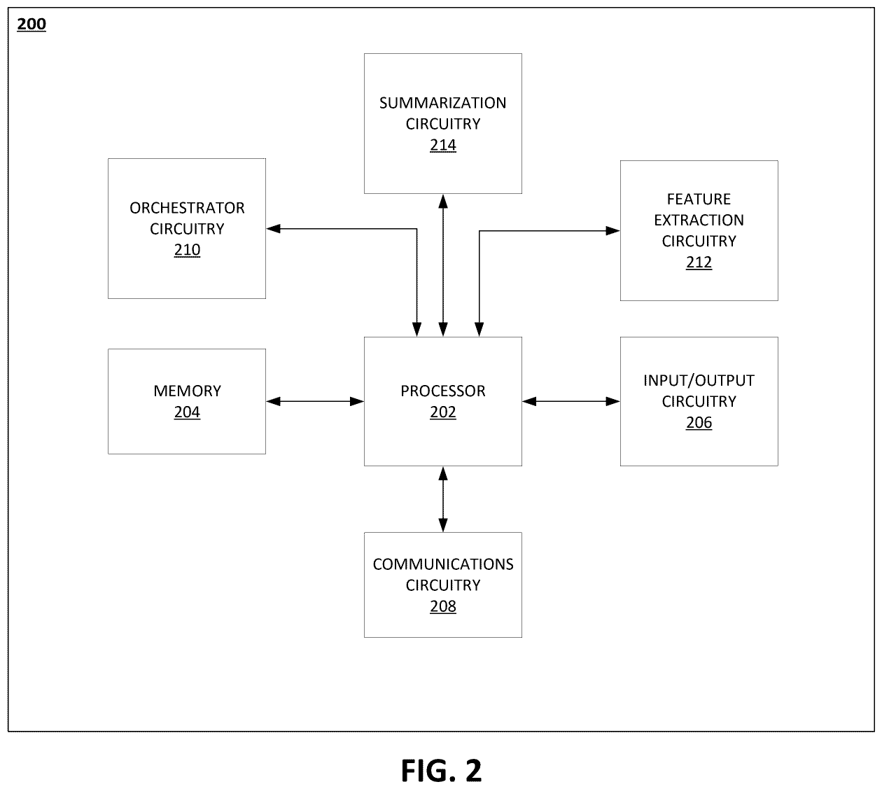

FIG. 2 illustrates a block diagram of an apparatus 200 in accordance with some example embodiments. For example, in some embodiments, Alert group summarization system 101 (or one or more portions thereof), if embodied in a particular embodiment, may be embodied by one or more apparatuses 200. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the Alert group summarization system 101 or any subset thereof may be performed by a single apparatus 200 or multiple apparatuses 200. In some embodiments, the apparatus 200 may comprise one or a plurality of physical devices.

The apparatus 200 may include processor 202, memory 204, input/output circuitry 206, communications circuitry 208, orchestrator circuitry 210, feature extraction circuitry 212, and/or summarization circuitry 214. The apparatus 200 may be configured to execute the operations described herein. Although these components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 includes an orchestrator circuitry 210. The orchestrator circuitry 210 may include hardware components, software components, and/or a combination thereof configured to, with the processor 202, memory 204, input/output circuitry 206 and/or communications circuitry 208, perform one or more functions associated with an orchestrator module (as described above with reference to FIG. 1). In some embodiments, the orchestrator circuitry 210 may be configured to receive and/or transmit data, objects, and/or the like from and/or to one or more components of the apparatus 200, through, for example, the use of applications or APIs executed using a processor, such as the processor 202. It should also be appreciated that, in some embodiments, the orchestrator circuitry 210 may include a separate processor, specially configured field programmable gate array (FPGA), or application specific interface circuit (ASIC) to provide or otherwise facilitate access to such data, objects, and/or the like used by one or more other components of the apparatus 200. The orchestrator circuitry 210 may also provide for communication with other components of the apparatus, system and/or external systems via a network interface provided by the communications circuitry 208.

In some embodiments, the apparatus 200 includes a feature extraction circuitry 212. The feature extraction circuitry 212 may include hardware components, software components, and/or a combination thereof configured to, with the processor 202, memory 204, input/output circuitry 206 and/or communications circuitry 208, perform one or more functions associated with a feature extraction module (as described above with reference to FIG. 1). In some embodiments, the feature extraction circuitry 212 may be configured to receive and/or transmit data, objects, and/or the like from and/or to one or more components of the apparatus 200, through, for example, the use of applications or APIs executed using a processor, such as the processor 202. It should also be appreciated that, in some embodiments, the feature extraction circuitry 212 may include a separate processor, specially configured field programmable gate array (FPGA), or application specific interface circuit (ASIC) to provide or otherwise facilitate access to such data, objects, and/or the like used by one or more other components of the apparatus 200. The feature extraction circuitry 212 may also provide for communication with other components of the apparatus, system and/or external systems via a network interface provided by the communications circuitry 208.

In some embodiments, the apparatus 200 includes a summarization circuitry 214. The summarization circuitry 214 may include hardware components, software components, and/or a combination thereof configured to, with the processor 202, memory 204, input/output circuitry 206 and/or communications circuitry 208, perform one or more functions associated with a summarization module (as described above with reference to FIG. 1). In some embodiments, the summarization circuitry 214 may be configured to receive and/or transmit data, objects, and/or the like from and/or to one or more components of the apparatus 200, through, for example, the use of applications or APIs executed using a processor, such as the processor 202. It should also be appreciated that, in some embodiments, the summarization circuitry 214 may include a separate processor, specially configured field programmable gate array (FPGA), or application specific interface circuit (ASIC) to provide or otherwise facilitate access to such data, objects, and/or the like used by one or more other components of the apparatus 200. The summarization circuitry 214 may also provide for communication with other components of the apparatus, system and/or external systems via a network interface provided by the communications circuitry 208.

Additionally or alternatively, in some embodiments, two or more of the sets of circuitries embodying processor 202, memory 204, input/output circuitry 206, communications circuitry 208, orchestrator circuitry 210, feature extraction circuitry 212, and/or summarization circuitry 214 are combinable. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, orchestrator circuitry 210, feature extraction circuitry 212, and/or summarization circuitry 214 are combined into a single module embodied in hardware, software, firmware, and/or a combination thereof. Similarly, in some embodiments, one or more of the sets of circuitry, for example, orchestrator circuitry 210, feature extraction circuitry 212, and/or summarization circuitry 214 is/are combined with the processor 202, such that the processor 202 performs one or more of the operations described above with respect to each of these sets of circuitry embodied by orchestrator circuitry 210, feature extraction circuitry 212, and/or summarization circuitry 214.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

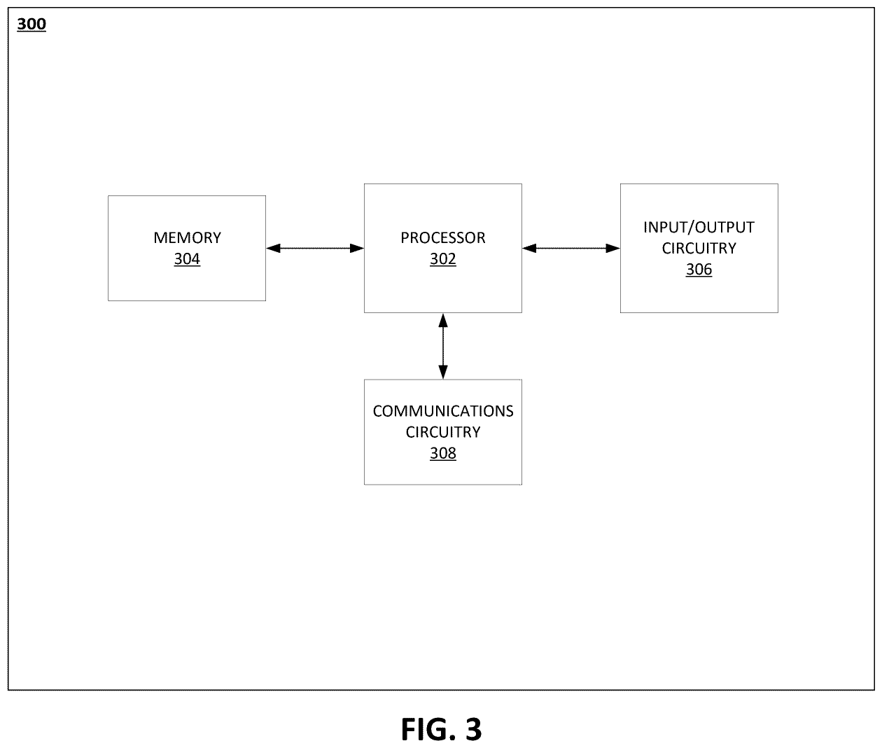

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Exemplary Data Flows and Operations

As indicated, some embodiments of the present disclosure make important technical contributions to alert management systems and/or techniques. In particular, systems and methods are disclosed herein that implement a specially-configured alert group summarization process for improving alert management system that leverages on or more machine learning models. By doing so, alert group summarization techniques described herein may provide an improvement in alert management systems that may be practically applied to improve various computing tasks, including alert management tasks.

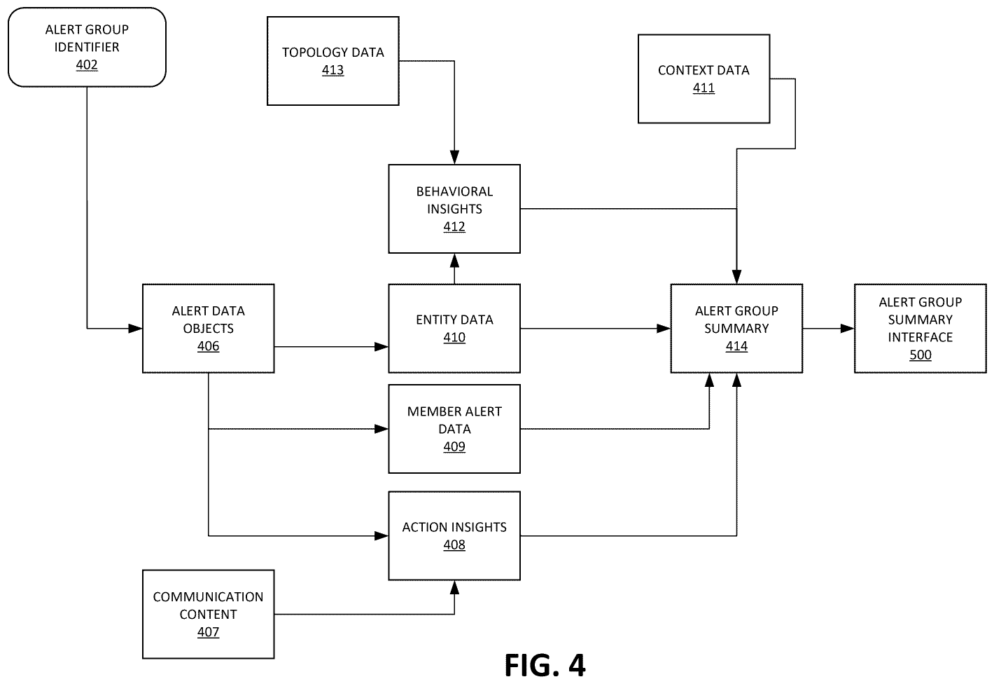

FIG. 4 illustrates a visualization of an example data environment for generating an alert group summary in accordance with at least some embodiments of the present disclosure.

In some embodiments, an alert group comprising a plurality of alert data objects 406 is identified. In some embodiments, the plurality of alert data objects comprise a subset of the alert data objects in the alert group deemed representative of the alert group. In some embodiments, identifying the alert group comprises receiving an alert group identifier 402, and identifying the alert group based on the alert group identifier 402. In some embodiments, the alert group identifier is received via user interface, such as a web user interface. For example, the alert group identifier may be input by a user via the user interface.

In some embodiments, an alert group is a data entity that describes a group of alert data objects that are deemed to be related based on one or more grouping criteria. For example, an alert group may comprise a plurality of alert data objects that are similar to each other and/or correlate with each other based on one or more grouping criteria (e.g., one or more similarity criteria, one or more correlation criteria, one or more temporal criteria, and/or the like). For example, an alert group may be generated by correlating topological and temporal alerts. In some embodiments, an alert group describes an output of a model such as an alert clustering machine learning model configured to group alert data objects into alert groups.

In some embodiments, grouping criteria is a data entity that describes an attribute based on which a set of alert data objects can be separated into or otherwise associated with an alert group. Examples of grouping criteria include similarity between alert data objects based on alert features (e.g., common entities, common alert message, common team identifier, common alert creation window (e.g., days of the week), and/or the like), correlation between alert data objects based on alert features, topology data, temporality, and/or the like.

In some embodiments, an alert group identifier is one or more items or elements by which an alert group may be uniquely identified from other alert groups. An alert group identifier may be in the form of text string(s), numerical character(s), alphabetical character(s), alphanumeric code(s), American Standard Code for information Interchange (ASCII) characters(s), and/or the like.

In some embodiments, an alert data object is data object that describes one or more properties associated with execution, operation, maintenance, configuration management, and/or the like of a software application framework, being monitored (e.g., by alert management system), during and/or post an abnormal state (e.g., unplanned interruption to a service, reduction in the quality of a service, failure of a service, or the like) of the software application framework. An alert data object may describe an alert (e.g., an indication of an event that occurred in an external system, application, or service that is monitored by an alert management system, monitored by a program associated or integrated with an alert management system, or directly associated with an alert management system). In some embodiments, the alert data object includes a plurality of alert attribute data fields associated with the alert. Examples of alert attribute data fields of an alert data object include a message attribute data field that stores message data that indicates the basis of the alert creation, a teams attribute data field that includes the names of the teams that were added to the alert to be notified, a recipients attribute data field that includes the names of recipients that were added to the alert to be notified, an entity attribute data field that is used to specify the domain that the alert is related to, such as name of the service, server, or application, a description attribute data field that is used to keep a long description related with the alert, action notes attribute data field that is used to specify and/or summary actions (e.g., corrective actions, or the like) taken with respect to the alert, and/or an extra properties field that is used to keep additional key-value pairs related with the alert.

Other examples of alert attribute data fields include status attribute data field that contains the information of alert state, a recipient states attribute data field that shows the last state of the recipient users according to the alert, a notes attributes field that shows the notes (e.g., alert summary notes, or the like) that were added initially or later by users, and an activity log attributes field that provides any user or system activity related to an alert along with their update times on this section with the time sequence. Alert creation, user interactions including actions, notifying or skipping to notify a user, de-duplication events are some of the example activities. A user may be required to manually enter some of the attribute data field information mentioned above, and/or an alert management client or server may automatically populate some attribute data field information.

Other examples of alert attribute data fields of an alert data object include one or more numerical attribute data fields, such as a numerical attribute data field describing the deduplication count of the alert data object, a numerical attribute data field describing the number of other alert data objects created during a defined window (e.g., 15-minute window or the like) around the creation time of the alert data object, a numerical attribute data field describing the number of nth priority level alert data objects created during a defined window around the creation time of the alert data object, an average inter-arrival time of alert data objects at the creation time of the alert data object, and/or the like. Other examples of alert attribute data fields of an alert data object include one or more categorical attribute data fields, such as a categorical attribute data field describing the priority level of the alert data object (e.g., describing whether the alert data object is P1, P2, P3, P4, or P5), a categorical attribute data field describing the alert source of the alert data object (e.g., describing whether the alert data object is user-initiated, system-initiated, request-initiated, and/or the like), a categorical attribute data field describing whether the creation time of the alert data object is a weekend or a weekday, and/or the like. Other examples of alert attribute data fields for an alert data object includes an embedded representation of a natural language format field (e.g., an alert message field) of the alert data object, such as an embedded representation generated based on the output of processing the alert message field of the alert data object using a text encoder machine learning model.

In some embodiments, one or more alert features associated with the alert group (e.g., alert group identified by the alert group identifier 402) is extracted, based on the plurality of alert data objects 406 and using one or more feature extraction models. In some embodiments, the one or more alert features comprise entity data 410 corresponding to one or more entities associated with the alert group. In some embodiments, the entity data 410 describes the names of the domain that an alert data object in the alert group is related, such as name of a service, server, or application. In some embodiments, additionally or alternatively, the entity data 410 includes region(s), reason(s), and/or error code(s) associated with the alert group. It would be appreciated that the above entity data examples are not intended to be limiting and the entity data may include other and/or different entities associated with the alert group.

In some embodiments, additionally or alternatively, the one or more alert features comprise member alert data (e.g., action notes extracted from action notes attribute data fields of one or more alert data objects of the plurality of alert data objects, problem description extracted from problem description attribute data filed of or more alert data object of the plurality of alert data objects, or the like). For example, the member alert data may comprise user-generated content and may form a portion of action insights 408 illustrated in FIG. In some embodiments, the action insights 408 may further include action-related communication content (e.g., as described above). In some embodiments, the action-related communication content may be extracted from the communication content 407 (e.g., rendered via one or more communication platforms) using one or more feature extraction models which may or may not be the same as the one or more feature extraction models used to extract alert features from the alert data objects 406.

In some embodiments, the one or more feature extraction models comprise a BILSTM-CRF-NER configured to extract the entity data 410 from the plurality of alert data objects 406. In some embodiments, the plurality of alert data objects may be input into the BILSTM-CRF-NER to output entity data 410 that comprise entities associated with the alert data objects. In some embodiments, member alert data may be extracted from the alert data objects 406 and input to the BILSTM-CRF-NER to output the entity data 410. In some embodiments, the communication content 407 may be input into the BILSTM-CRF-NER to output action-related communication content that form a portion of the action insights 408.

In some embodiments, user-generated content is data, objects, and/or the like that is input by user. Examples of user-generated content include data input by a user in an attribute data field of an alert data object such as alert descriptions, alert notes, responder names, and/or the like. Other examples of user-generated content include data (e.g., action-related communication content) input by a user via a communication platform such as Slack, Teams, or the like. In some embodiments, user-generated content is a type of data classification that is associated with a data object created by one or more users of an application that generated the data object (e.g., free-form text, audio files, video files, the like, or combinations thereof).

In some embodiments, action-related communication content describes content (e.g., text or other media) of a communication platform. In various embodiments, action-related communication content comprises a message transmitted, posted, and/or otherwise shared among and/or within a group via a communication platform. Action-related communication content and/or a portion of action-related communication content may be capable of being extracted, transmitted, received, and/or stored. Action-related communication content and/or a portion of action-related communication content may be sent and received between multiple computers, multiple servers, and may pass through multiple relays, routers, network access points, base stations, hosts, and/or the like, which is sometimes referred to as a “network.” Action-related communication content may include various data associated with an alert. By way of example, action-related communication content may include corrective action data (e.g., text data that describes one or more corrective actions mentioned and/or discussed within a communication platform). Action-related communication content may form a portion of communication content (e.g., messages transmitted, posted, and/or otherwise shared among and/or within a group via a communication platform)

In some embodiments, a communication platform is an electronic communication medium configured for providing collaborative capabilities that enable a plurality of client computing devices to transmit, display, receive, access, and/or engage with action-related communication content generated by the plurality of client computing devices, wherein each client computing device of the plurality of client computing devices may be associated with a member identifier. A communication platform may comprise an application configured to provide chat services (e.g., iMessage, Google Messages, Slack, MS Teams, WhatsApp, and/or the like). A communication platform may comprise communication content input by users of the communication platform. Communication content and/or a portion of communication content may be sent and received between multiple computers, multiple servers, and may pass through multiple relays, routers, network access points, base stations, hosts, and/or the like.

In some embodiments, behavioral insights 412 is generated based on the alert data objects 406 and topology data 413. For example, the behavioral insights 412 may be generated based on entity data 410 extracted from the alert data objects 406 and the topology data 413. For example, fault localization data, blast radius data, fault propagation data, and/or other behavioral insights for the alert group may be generated using at least one machine learning model configured to receive the entity data 410 and topology data 413 as input and output behavioral insight 412 comprising fault localization data, blast radius data, fault propagation path data, and/or the like for the alert group.

In some embodiments, an alert group summary 414 is generated for the alert group based on input data set comprising the action insights 408, semantic insights (e.g., member alert data 409 and/or entity data 410), behavioral insights 412 extracted from the alert data objects 406 and/or communication content 407. In some embodiments, additionally, the input data set may include insights generated via similar historical alert group(s) and/or features of the similar historical alert group(s). In some embodiments, one or more of the action insights 408, semantic insights, or behavioral insights 412 may be generated based at least in part on features extracted from similar historical alert group(s). In some embodiments, similar historical alert group(s) may be identified based on an alert group signature associated with the alert group. In some embodiments, additionally, the input data set may include context data 411 (e.g., relevant snippets) obtained via a domain knowledge graph. For example, the context data 411 may comprise query result output by the domain knowledge graph responsive to a query relating to user-generated content (e.g., action notes, action-related communication content, problem description, and/or the like) extracted from alert data objects 406 and/or communication content 407. In some embodiments, a pre-trained LLM, is leveraged to generate the alert group summary 414 using retrieval-augment generation and based on the input data set. For example, the pre-trained LLM may be configured to receive the input data set (as described above) and generate an alert group summary 414 that is a deep summarization of the information associated with the alert data objects in the alert group.

In some embodiments, the alert group summary 414 comprises a plurality of alert group summary segments. In some embodiments, the plurality of alert group summary segments comprises a title segment, a comprehensive summary segment, an actions summary segment, and a timeline segment. In some embodiments, the title segment (e.g., concise summary segment) comprises data that describes a primary and/or common problem associated with alert group (e.g., primary and/or common problem displayed or surfaced by the alert group). Alternatively or additionally, the title segment may comprise data that describes information about services affected along with the problems affecting the individual affected services. In some embodiments, the comprehensive summary segment comprises data that describes the primary/common problem associated with the alert group in detail relative to the title as well as information specific to the individual alert data objects (e.g., individual alerts) of the alert group. In this manner important information is not omitted. Additionally, the comprehensive summary segment may comprise behavioral information such as the root cause (e.g., service(s) that caused the problem(s) associated with the alert group), blast radius, and fault propagation path for the alert data objects in the alert group. In some embodiments, the actions summary segment describes the actions (e.g., corrective actions that have been taken on the alert data objects in the alert group).

In some embodiments, an alert group summary interface 500 is caused to be rendered to a display of a user device (e.g., a client computing device), wherein the alert group summary interface comprises at least a portion of the alert group summary as described below.

### Example Interfaces

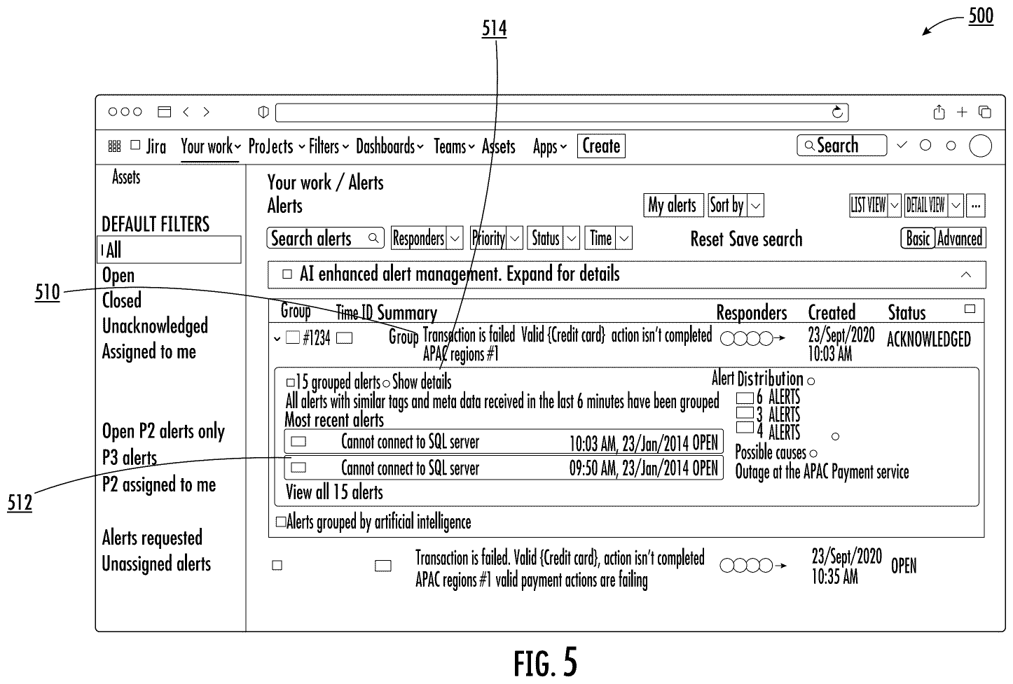

FIG. 5, depicts an example alert group summary interface 500 configured in accordance with at least some embodiments of the present disclosure. The depicted alert group summary interface 500 comprises one or more alert group summary components, including, but not limited to title component 510 that visually depicts the title segment of the alert group summary for the alert group, a timeline component that visually depicts the timeline for the alert data objects in the alert group (e.g., arrival density of alerts (represented as alert data objects) in the alert group), a view details engagement component 512 that when engaged by a user causes rendering of an interface 514 that displays the alert group summary with each segment of the alert group summary or a subset of the alert group summary (e.g., comprehensive summary segment only, comprehensive summary segment and actions summary segment only, or other combinations thereof).

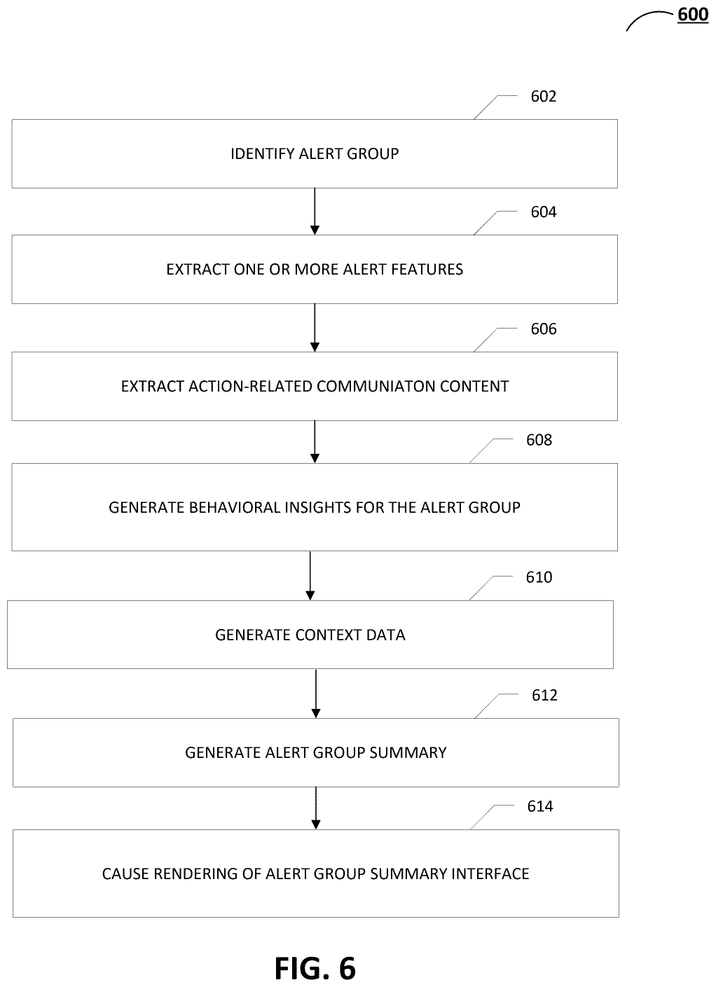

FIG. 6 is a flowchart diagram of an example process 600 for generating alert group summaries in accordance with some embodiments discussed herein. The process 600 may be implemented by one or more computing devices, entities, and/or systems described herein.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes at step/operation 602, identifying an alert group. For example, the apparatus 200 (e.g., orchestrator circuitry thereof) may identify an alert group comprising a plurality of alert data objects. In some embodiments, identifying the alert group comprises receiving an alert group identifier and identifying the alert group based on the alert group identifier.

In some embodiments, the process 600 includes at step/operation 604, extracting one or more alert features associated with the alert group. For example, the apparatus 200 may extract one or more alert features associated with alert group identified by the alert group identifier based on the plurality of alert data objects and using one or more feature extraction models. In some embodiments, the one or more alert features comprises entity data corresponding to one or more entities associated with the alert group. In some embodiments, the one or more feature extraction models comprises a BILSTM-CRF-NER model that is leveraged to extract the entity data from the plurality of alert data objects. In some embodiments, the plurality of alert data objects may be input into the BILSTM-CRF-NER to output entity data that comprise entities associated with the alert data objects. In some embodiments, alert data associated with each alert data object may be extracted from the alert data objects and input to the BILSTM-CRF-NER to output the entity data. In some embodiments, a portion of the one or more alert features (e.g., entity data, member alert data, or the like) may represent semantic insights for the alert group Alternatively or additionally, in some embodiments, a portion of the alert features (e.g., action notes, or the like) may represent action insights for the alert group.

In some embodiments, the process 600 includes at step/operation 606, extracting action-related communication content associated with the alert group. For example, the apparatus 200 may extract action-related communication content associated with the alert group from one or more communication platforms. For example, the action-related communication content may be extracted from communication content generated via the one or more communication platforms (e.g., Slack, Teams, or the like). The action-related communication content may describe one or more actions taken by a user associated with the alert group.

In some embodiments, the process 600 includes at step/operation 608, generating behavioral insights for the alert group. For example, the apparatus 200 may generate behavioral insights for the alert group using one or more machine learning models and based on the alert data objects in the alert group and topology data (e.g., based on entity data extracted from the alert data objects and topology data).

In some embodiments, the process 600 includes at step/operation 610, generating context data. The context data may comprise relevant snippets from a domain knowledge graph. For example, the apparatus 200 may query a domain knowledge graph based on user-generated content (e.g., action notes, action-related communication content, problem description, and/or the like) extracted from alert data objects and/or communication platforms and receive a query result. The query result, for example, may comprise context data (e.g., additional information such as, explanations, links, or the like related to user-generated content) configured to allow for generation an alert group summary that is a deep summarization as described further below.

In some embodiments, the process 600 includes at step/operation 612, generating an alert group summary for the alert group. For example, the apparatus 200 may generate an alert group summary for the alert group based on input data set comprising the action insights (e.g., data that describes actions taken by users with respect to one or more alert data objects in the alert group including, for example, action notes extracted from the alert data objects and/or action-related communication content extracted from one or more communication platforms), semantic insights (e.g., member alert data such as problem description, entity data, and/or the like), behavioral insights (e.g., fault localization, blast radius, fault propagation path), and/or context data from a domain knowledge graph. In some embodiments, a pre-trained LLM is leveraged to generate the alert group summary using retrieval-augment generation. For example, the pre-trained LLM may be configured to generate the alert group summary based on input that includes context data obtained via a domain knowledge graph (e.g., operations team knowledge graph/base for an enterprise such as, for example, Atlassian Inc.). In this regard, in various embodiments, the alert group summary is a deep summarization (e.g., not merely an abstractive summary) for the alert group that, for example, tells a story with respect to the alert group which may include problem description, affected services, actions taken, timeline, and/or the like. For example, while an abstractive summarization for an alert group may be generated by extracting data from alert attribute data fields of alert data objects associated with the alert group and paraphrasing the text data to provide a short description of key ideas from the text data, a deep summarization of an alert group as described herein augments data extracted via alert attribute data fields of the alert data objects with additional relevant information obtained via a domain knowledge graph (as described above) to provide a deep summary of the various information (e.g., including the additional relevant information) associated with the alert group.

In some embodiments, the process 600 includes at step/operation 614, causing rendering of an alert group summary interface. For example, the apparatus 200 may cause rendering of an alert group summary interface on a display of a user device (e.g., a client computing device), wherein the alert group summary interface comprises at least a portion of the alert group summary.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### Conclusion

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus for generating alert group summaries, the apparatus comprising at least one processor and at least one memory including program code, the at least one memory and the program code configured to, with the at least one processor, cause the apparatus to at least:
identify an alert group comprising a plurality of alert data objects;
extract, based on the plurality of alert data objects and using one or more feature extraction models, one or more alert features associated with the alert group;
extract action-related communication content for the alert group;
generate, using one or more machine learning models and based on an input data set comprising the one or more alert features and the action-related communication content, an alert group summary for the alert group; and
cause rendering of an alert group summary interface on a display of a user device, wherein the alert group summary interface comprises at least a portion of the alert group summary.

2. The apparatus of claim 1, wherein the one or more alert features comprises entity data corresponding to one or more entities associated with the alert group.

3. The apparatus of claim 2, wherein the input data set further comprises behavioral insights comprising one or more of fault localization data, blast radius data, or fault propagation path data.

4. The apparatus of claim 3, wherein the behavioral insights is generated based on the entity data and topology data.

5. The apparatus of claim 2, wherein the one or more feature extraction models comprises a BILSTM-CRF-NER model, wherein the at least one memory and the program code are configured to, with the at least one processor, cause the apparatus to extract the entity data from the plurality of alert data objects using the BILSTM-CRF-NER model.

6. The apparatus of claim 1, wherein the one or more alert features comprises action notes corresponding to one or more actions by a user associated with the alert group.

7. The apparatus of claim 1, wherein the one or more machine learning models comprise a pre-trained LLM, wherein the at least one memory and the program code are configured to, with the at least one processor, cause the apparatus to generate the alert group summary via the pre-trained LLM using retrieval augmented generation and based on the input data set.

8. The apparatus of claim 7, wherein the input data set further comprises context data obtained via a domain knowledge graph.

9. The apparatus of claim 1, wherein the alert group summary comprises a title segment, a comprehensive summary segment, an actions summary segment, and a timeline segment.

10. The apparatus of claim 1, wherein the at least one memory and the program code are configured to, with the at least one processor, cause the apparatus to at least identify the alert group by:
receiving an alert group identifier; and
identifying the alert group based on the alert group identifier.

11. A computer-implemented method for generating alert group summaries, the computer-implemented method comprising:
extracting, based on a plurality of alert data objects of an alert group and using one or more feature extraction models, one or more alert features associated with the alert group;
generating, using one or more machine learning models and based on an input data set comprising the one or more alert features, an alert group summary for the alert group; and
causing rendering of an alert group summary interface on a display of a user device, wherein the alert group summary interface comprises at least a portion of the alert group summary.

12. The computer-implemented method of claim 11, wherein the one or more alert features comprise entity data corresponding to one or more entities associated with the alert group.

13. The computer-implemented method of claim 12, wherein the input data set further comprises behavioral insights comprising one or more of fault localization data, blast radius data, or fault propagation path data.

14. The computer-implemented method of claim 13, wherein the behavioral insights is generated based on the entity data and topology data.

15. The computer-implemented method of claim 12, wherein the one or more feature extraction models comprises a BILSTM-CRF-NER model, wherein extracting the one or more alert features comprises extracting the entity data from the plurality of alert data objects using the BILSTM-CRF-NER model.

16. The computer-implemented method of claim 11, wherein the one or more alert features comprises action notes corresponding to one or more actions by a user associated with the alert group.

17. The computer-implemented method of claim 11, wherein the one or more machine learning models comprises a pre-trained LLM, wherein generating the alert group summary comprises retrieval augmented generation via the pre-trained LLM and based on the input data set.

18. The computer-implemented method of claim 17, wherein the input data set further comprises context data obtained via a domain knowledge graph.

19. The computer-implemented method of claim 11, wherein the alert group summary further comprises a title segment, a comprehensive summary segment, an actions summary segment, and a timeline segment.

20. At least one non-transitory computer-readable storage medium for generating alert group summaries, the at least one non-transitory computer-readable storage medium having computer coded instructions configured to, when executed by at least one processor:
identify an alert group comprising a plurality of alert data objects;
generate, using one or more machine learning models and based on one or more alert features associated with the alert group and action-related communication content from one or more communication platforms, an alert group summary for the alert group; and
cause rendering of an alert group summary interface on a display of a user device, wherein the alert group summary interface comprises at least a portion of the alert group summary.
